(19) United States
(12) Patent Application Publication
(10) Pub. No.: US 2022/0317614 A1
(43) Pub. Date: Oct. 6, 2022

(54) IMAGE FORMING APPARATUS

(71) Applicant: KYOCERA Document Solutions Inc., Osaka (JP)

(72) Inventor: Takeo SHIMIZU, Osaka-shi (JP)

(73) Assignee: KYOCERA Document Solutions Inc., Osaka (JP)

(21) Appl. No.: 17/704,756

(22) Filed: Mar. 25, 2022

(30) Foreign Application Priority Data
Mar. 31, 2021 (JP) 2021-060275

(51) Int. Cl. G03G 15/00

(52) U.S. Cl. CPC G03G 15/556; G03G 15/502

(57) ABSTRACT

An image forming apparatus includes an image forming section, a display section, and a controller. The image forming section forms an image on a recording medium. The display section displays a message to a user. The controller controls operation of the display section. In causing the display section to display a remaining amount display icon indicating a remaining amount display bar with a length that represents a remaining amount of a consumable used in the image forming section, the controller causes the display section to display in an enlarged size the remaining amount display icon indicating the remaining amount display bar with a length corresponding to a maximum remaining amount and continuously changes the length of the remaining amount display bar from the length corresponding to the maximum remaining amount to a length corresponding to a current remaining amount.

### INCORPORATION BY REFERENCE

The present application claims priority under 35 U.S.C. § 119 to Japanese Patent Application No. 2021-060275, filed on Mar. 31, 2021. The contents of this application are incorporated herein by reference in their entirety.

### BACKGROUND

The present disclosure relates to an image forming apparatus.

Once an error state is left for a long time in an information processing device, the information processing device gradually increases the display area of an error message to try to ensure that a user knows that an error has occurred.

### SUMMARY

An image forming apparatus according to an aspect of the present disclosure includes an image forming section, a display section, and a controller. The image forming section forms an image on a recording medium. The display section displays a message to a user. The controller controls operation of the display section. In causing the display section to display a remaining amount display icon indicating a remaining amount display bar with a length that represents a remaining amount of a consumable used in the image forming section, the controller causes the display section to display in an enlarged size the remaining amount display icon indicating the remaining amount display bar with a length corresponding to a maximum remaining amount and continuously changes the length of the remaining amount display bar from the length corresponding to the maximum remaining amount to a length corresponding to a current remaining amount.

### BRIEF DESCRIPTION OF THE DRAWINGS

FIG. 1 is a schematic diagram illustrating an example of the configuration of an image forming apparatus according to an embodiment.

FIG. 2 is a block diagram of an example of the circuit configuration of the image forming apparatus.

FIG. 3 is a flowchart depicting an example of an operation of a controller.

FIGS. 4A, 4B, and 4C each are a diagram illustrating an example of display by a touch panel.

### DETAILED DESCRIPTION

The following describes an embodiment of the present disclosure with reference to the accompanying drawings. Note that elements that are the same or equivalent are indicated by the same reference signs in the drawings and description thereof is not repeated.

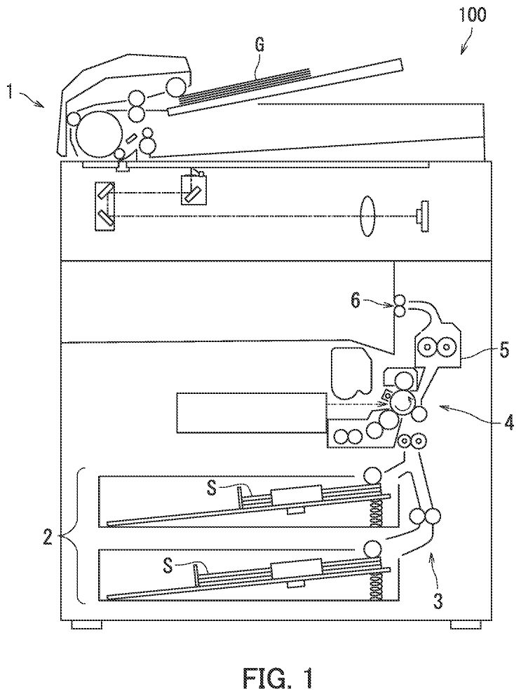

With reference to FIG. 1, an image forming apparatus 100 according to an embodiment will be described below. FIG. 1 is a schematic diagram illustrating an example of the configuration of the image forming apparatus 100. The image forming apparatus 100 is a copier, a printer, a facsimile machine, or a multifunction peripheral having functions of these, for example. The following describes an embodiment in a case in which the image forming apparatus 100 is a color multifunction peripheral.

As illustrated in FIG. 1, the image forming apparatus 100 includes a reading section 1, a feeding section 2, a conveyance section 3, an image forming section 4, a fixing section 5, and an ejection section 6.

The reading section 1 reads an image of a document G. The reading section 1 generates image data from the read image. The feeding section 2 accommodates a plurality of sheets S, and feed the sheets S to the conveyance section 3 one at a time. The sheets S are made from paper or synthetic resin, for example. The conveyance section 3 includes a plurality of conveyance roller pairs, and conveys each sheet S to the image forming section 4. The sheet S corresponds to an example of a “recording medium”.

The image forming section 4 electrographically forms a toner image on the sheet S. The image forming section 4 includes a photosensitive drum, a charger, a light exposure device, a development device, a replenishment device, a transfer device, a cleaner, and a static eliminator. The replenishment device replenishes the development device with toners that each are a consumable. The image forming section 4 performs color printing using the toners which are four toners mutually different in colors. However, the configuration of the image forming section 4 illustrated in FIG. 1 is for printing with one of the four colors and the configurations for printing with the other three colors are not illustrated.

The fixing section 5 applies heat and pressure to the toner image to fix the toner image to the sheet S. The conveyance section 3 conveys the sheet S with the toner image fixed thereto to the ejection section 6. The ejection section 6 ejects the sheet S out of the image forming apparatus 100.

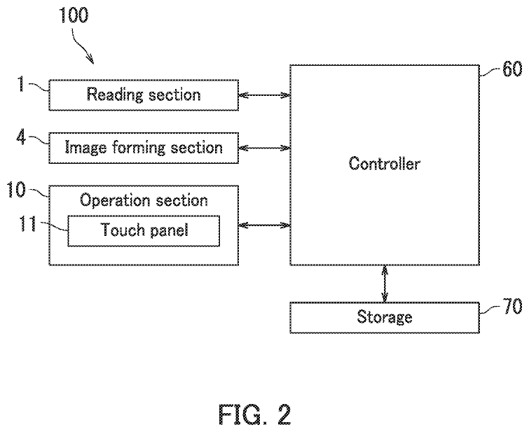

A circuit configuration of the image forming apparatus 100 will be described next with reference to FIGS. 1 and 2. FIG. 2 is a block diagram of an example of the circuit configuration of the image forming apparatus 100.

As illustrated in FIG. 2, the image forming apparatus 100 further includes an operation section 10, a controller 60, and storage 70.

The operation section 10 serves as both an input device for receiving various user operations and a display device for displaying a message to a user. The operation section 10 includes a touch panel 11 and a plurality of push buttons, for example. The touch panel 11 corresponds to an example of a “display section”.

The storage 70 includes a storage device, and stores data and computer programs therein. The storage 70 includes a main storage device such as semiconductor memory and an auxiliary storage device such as a hard disk drive (HDD).

The controller 60 includes a processor such as a central processing unit (CPU), and executes the computer programs stored in the storage 70 to control each element of the image forming apparatus 100. Specifically, the controller 60 controls each operation of the reading section 1, the image forming section 4, and the operation section 10.

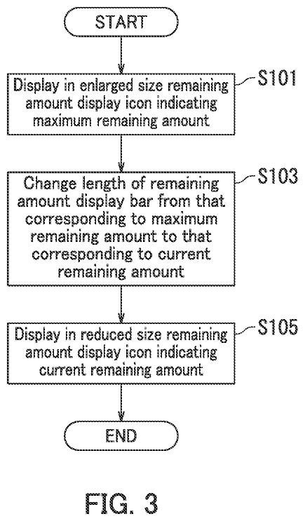

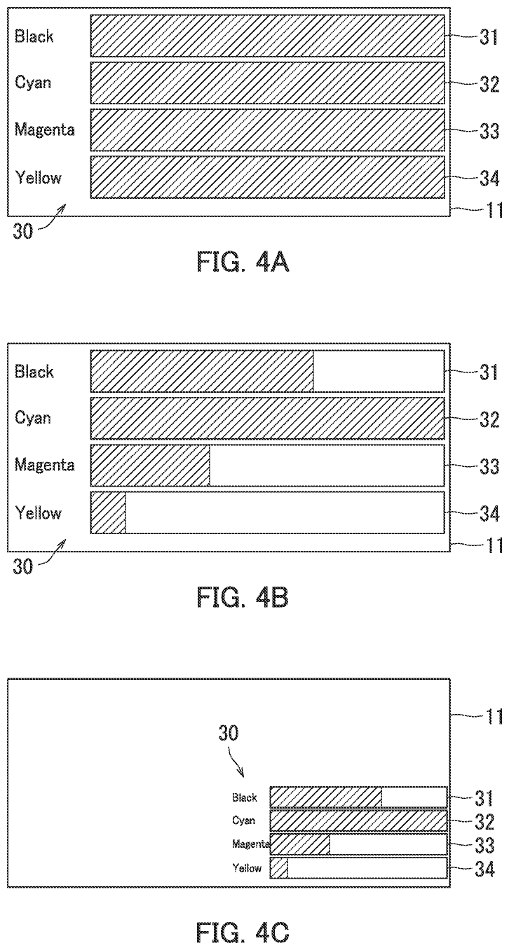

An operation of the controller 60 and display of the touch panel 11 will be described next with reference to FIGS. 3, 4A, 4B, and 4C. FIG. 3 is a flowchart depicting an example of the operation of the controller 60. FIGS. 4A to 4C each are a diagram illustrating an example of display of the touch panel 11.

Step S101: The controller 60 causes the touch panel 11 to display on the entire screen thereof a remaining amount display icon 30 in an enlarged size that indicates a maximum remaining amount of each toner as illustrated in FIGS. 3 and 4A.

The remaining amount display icon 30 includes a first remaining amount display bar 31, a second remaining amount display bar 32, a third remaining amount display bar 33, and a fourth remaining amount display bar 34. The length of the first remaining amount display bar 31 represents an amount of remaining black toner. The length of the second remaining amount display bar 32 represents an amount of remaining cyan toner. The length of the third remaining amount display bar 33 represents an amount of remaining magenta toner. The length of the fourth remaining amount display bar 34 represents an amount of remaining yellow toner. In Step S101, each of the first to fourth remaining amount display bars 31 to 34 has a length corresponding to the maximum remaining amount of a corresponding one of the toners. The first to fourth remaining amount display bars 31 to 34 each correspond to an example of a “remaining amount display bar”.

Step S103: Next, the controller 60 continuously changes each length of the first to fourth remaining amount display bars 31 to 34 from the length corresponding to the maximum remaining amount to a length corresponding to a current remaining amount as illustrated in FIGS. 3 and 4B. As a result, it can be ensured that the user knows each current degree of consumption of the toners in different colors.

Step S105: Next, the controller 60 causes the touch panel 11 to display in a reduced size the remaining amount display icon 30 indicating the current remaining amount of each toner as illustrated in FIGS. 3 and 4C. As a result, occupation by the remaining amount display icon 30 in the screen of the touch panel 11 is released. When the processing in Step S105 ends, the operation of the controller 60 ends.

According to the above embodiment, the remaining amount of a consumable such as a toner can be displayed in an easy-to-understand manner for the user in the image forming apparatus 100.

An embodiment of the present disclosure has been described so far with reference to the drawings. However, the present disclosure is not limited to the above embodiment and may be implemented in various manners within a scope not departing from the gist thereof. Various disclosures can be formed by appropriately combining elements of configuration disclosed in the above embodiment. For example, some elements of configuration may be omitted from all the elements of configuration indicated in the embodiment. The drawings schematically illustrate elements of configuration in order to facilitate understanding. Properties such as the number of each element of configuration illustrated in the drawings may differ from actual properties in order to facilitate preparation of the drawings. Furthermore, each element of configuration indicated in the above embodiment is an example and not a particular limitation. Various alterations may be made so long as there is no substantial deviation from the effects of the present disclosure.

The image forming apparatus 100 is an electrographic image forming apparatus that consumes toners in the above embodiment. However, the present disclosure is not limited to the above. The image forming apparatus 100 may be an inkjet image forming apparatus that consumes inks, for example.

What is claimed is:

1. An image forming apparatus comprising:
an image forming section configured to form an image on a recording medium;
a display section configured to display a message to a user; and
a controller configured to control operation of the display section, wherein
in causing the display section to display a remaining amount display icon indicating a remaining amount display bar with a length that represents a remaining amount of a consumable used in the image forming section, the controller causes the display section to display in an enlarged size the remaining amount display icon indicating the remaining amount display bar with a length corresponding to a maximum remaining amount and continuously changes the length of the remaining amount display bar from the length corresponding to the maximum remaining amount to a length corresponding to a current remaining amount.

2. The image forming apparatus according to claim 1, wherein
after the remaining amount display bar on the display section is continuously changed, the controller causes the display section to display in a reduced size the remaining amount display icon indicating the remaining amount bar with the length corresponding to the current remaining amount.

3. The image forming apparatus according to claim 1, wherein
the consumable is a toner used for development in the image forming section.
